(19) United States
(12) Patent Application Publication
(10) Pub. No.: US 2023/0347783 A1
(43) Pub. Date: Nov. 2, 2023

(54) METHOD FOR REPLACING A DRIVE BATTERY OF AN ELECTRIC MOTOR VEHICLE

(71) Applicant: Robert Bosch GmbH, Stuttgart (DE)

(72) Inventor: Stefan Nordbruch, Leonberg (DE)

(21) Appl. No.: 18/191,529

(22) Filed: Mar. 28, 2023

(30) Foreign Application Priority Data
May 2, 2022 (DE) 10 2022 204 300.6

(51) Int. Cl. B60L 53/80; B60L 53/35; B60L 58/12

(52) U.S. Cl. CPC B60L 53/80; B60L 53/35; B60L 58/12

(57) ABSTRACT

A method for replacing a drive battery of an electric motor vehicle. The method includes: determining that the drive battery of the electric motor vehicle needs to be replaced, in response to the determination, controlling a drive battery replacement device such that it automatically replaces the drive battery of the electric motor vehicle while the electric motor vehicle is carrying out an AVP operation in a parking lot. A device, a system for replacing a drive battery of an electric motor vehicle, and a computer program and a machine-readable storage medium, are also described.

### CROSS REFERENCE

The present application claims the benefit under 35 U.S.C. § 119 of German Patent Application No. DE 10 2022 204 300.6 filed on May 2, 2022, which is expressly incorporated herein by reference in its entirety.

### FIELD

The present invention relates to a method for replacing a drive battery of an electric motor vehicle, a device, a system for replacing a drive battery of an electric motor vehicle, a computer program and a machine-readable storage medium.

### BACKGROUND INFORMATION

China Patent Application No. CN 112895971A describes a replacement of a vehicle battery.

U.S. Patent Application Publication No. US 2012/0316671 A1 describes a battery charging system and a battery replacement system.

German Patent Application No. DE 10 2017 008 645 A1 describes a method in which a vehicle is driven autonomously to a charging station to carry out a charging process and leaves the charging station autonomously after the charging process has ended.

The article “Autonomous Battery Swapping System and Methodologies of Electric Vehicles” by Feyijimi Adegbohun, Annette von Jouanne and Kwang Y. Lee, in Energies 2019, 12, 667; doi:10.3390/en12040667, published on Feb. 19, 2019, describes general information on the topic of autonomous battery swapping systems for electric vehicles.

### SUMMARY

An object of the present invention is to provide efficient replacing a drive battery of an electric motor vehicle.

This object may be achieved by the present invention. Advantageous embodiments of the present invention are disclosed herein.

According to a first aspect of the present invention, a method for replacing a drive battery of an electric motor vehicle is provided. According to an example embodiment of the present invention, the method includes the following steps:
determining that the drive battery of the electric motor vehicle needs to be replaced,
in response to the determination, controlling a drive battery replacement device such that it automatically replaces the drive battery of the electric motor vehicle while the electric motor vehicle is carrying out an AVP operation in a parking lot.

According to a second aspect of the present invention, a device is provided, which is configured to carry out all steps of the method according to the first aspect of the present invention.

According to a third aspect of the present invention, a system for replacing a drive battery of an electric motor vehicle is provided. According to an example embodiment of the present invention, the system includes:
a drive battery replacement device configured to replace a drive battery of an electric motor vehicle, and the device according to the second aspect of the present invention.

According to a fourth aspect of the present invention, a computer program is provided, which comprises instructions that, when the computer program is executed by a computer, for example by the device according to the second aspect of the present invention and/or by the system according to the third aspect of the present invention, prompt said computer to carry out a method according to the first aspect of the present invention.

According to a fifth aspect of the present invention, a machine-readable storage medium is provided, on which the computer program according to the fourth aspect of the present invention is stored.

The present invention is based on the insight that the above object is achieved by automatically replacing the drive battery of the electric motor vehicle while the motor vehicle is carrying out an AVP operation in the parking lot. This means that, according to the features described here, it is provided that the drive battery of the electric motor vehicle is automatically replaced or swapped in the parking lot. This replacement or swap is therefore carried out when the motor vehicle is in the parking lot. The time in which the motor vehicle is in the parking lot is thus not only used to carry out the AVP operation, but also efficiently to replace the drive battery. In comparison to charging the drive battery, for instance, replacing the drive battery has the advantage that the motor vehicle has a fully charged drive battery available more quickly, for example.

Replacing the drive battery is furthermore also useful and advantageous when charging stations in the parking lot are occupied by other electric motor vehicles, for example. In that case then, by replacing the drive battery, the electric motor vehicle can again have a fully charged drive battery, even when the drive battery cannot be charged at a charging station because all are occupied by other electric motor vehicles.

This, in particular, may produce the technical advantage that a concept for efficiently replacing the drive battery of an electric motor vehicle is provided.

In one example embodiment of the method of the present invention, it is provided that it is determined that the drive battery of the electric motor vehicle needs to be replaced when there is an existing request to replace the drive battery.

This, for example, may produce the technical advantage that the step of determining can be carried out efficiently. The request can originate from the driver of the electric motor vehicle, for example.

In one example embodiment of the method of the present invention, it is provided that the AVP operation specifies a maximum possible charging time for charging the drive battery in the parking lot, wherein a current capacity of the drive battery is ascertained, wherein it is determined that the drive battery of the electric motor vehicle needs to be replaced when the maximum possible charging time is not sufficient to charge the drive battery from the current capacity to a predetermined capacity in the parking lot.

This, for example, may produce the technical advantage that the step of determining can be carried out efficiently. The current capacity, also referred to in the context of the description as the state of charge, can, for instance, be sent from the electric motor vehicle to an infrastructure-side AVP system for carrying out the AVP operation. This means, for example, that an infrastructure-side AVP system for carrying out the AVP operation according to one embodiment of the method receives the current capacity from the motor vehicle, for example via a communication network, for example a WLAN network and/or a cellular network.

Replacing the drive battery includes removing the drive battery and inserting a different drive battery, for example.

In one example embodiment of the method of the present invention, it is provided that the electric motor vehicle comprises a drive battery cover. The drive battery cover can, for example, be opened and, for example, closed or locked. The drive battery cover covers a drive battery compartment of the electric motor vehicle, for instance, inside which the drive battery is located. The drive battery cover can be moved, for example between an open position, in which the drive battery compartment is accessible from the outside, i.e., from outside the electric motor vehicle, so that the drive battery can be replaced, and a closed position, in which the drive battery cover closes the drive battery compartment. The drive battery cover is accessible from an underside of the motor vehicle, for instance. The drive battery can, for example, be replaced from an underside of the electric motor vehicle.

The opening and/or locking and/or closing of the drive battery cover can be carried out from the motor vehicle side, for example. The replacement of the drive battery can, for example, be assisted by the motor vehicle.

This, for example, may produce the technical advantage that the drive battery can be replaced efficiently.

In one embodiment of the method it is provided that the drive battery replacement device comprises a robot, which is configured to replace the drive battery when the drive battery cover of the electric motor vehicle is open, wherein controlling the drive battery replacement device includes controlling the robot such that the robot replaces the drive battery when the drive battery cover of the electric motor vehicle is open.

This, for example, produces the technical advantage that the drive battery can be replaced efficiently.

In one example embodiment of the method of the present invention, it is provided that the drive battery cover of the electric motor vehicle is accessible from an underside of the electric motor vehicle, wherein the drive battery replacement device comprises a lifting platform which is configured to lift an electric motor vehicle to replace the drive battery from the underside, wherein controlling the drive battery replacement device includes controlling the lifting platform such that it lifts the electric motor vehicle to replace the drive battery from the underside of the electric motor vehicle, and wherein controlling the drive battery replacement device includes controlling the robot such that, after lifting the electric motor vehicle by means of the lifting platform, the robot replaces the drive battery when the drive battery cover is open, and wherein controlling the drive battery replacement device includes controlling the lifting platform such that the lifting platform lowers the electric motor vehicle after the drive battery has been replaced.

This, for example, may produce the technical advantage that the drive battery can be replaced efficiently.

In one example embodiment of the method of the present invention, it is provided that the AVP operation specifies that the motor vehicle is guided in an at least highly automated manner to and onto the lifting platform in order to lift the electric motor vehicle by means of the lifting platform.

In one example embodiment of the method of the present invention, it is provided that the robot is configured to open the drive battery cover and/or close the drive battery cover after replacement, wherein controlling the drive battery replacement device includes controlling the robot such that the robot opens the drive battery cover and/or closes the drive battery cover after replacement.

This, for example, may produce the technical advantage that the drive battery can be replaced efficiently.

In one example embodiment of the method of the present invention, it is provided that controlling the drive battery replacement device includes controlling the robot such that, after lifting the electric motor vehicle by means of the lifting platform, the robot opens the drive battery cover accessible from the underside of the electric motor vehicle from the underside of the electric motor vehicle and/or closes the drive battery cover after replacing the drive battery, wherein controlling the drive battery replacement device includes controlling the lifting platform such that it lowers the lifting platform after closing the drive battery cover.

This, for example, may produce the technical advantage that the drive battery can be replaced efficiently.

The robot can be assisted by the motor vehicle when opening the drive battery cover and/or closing and/or locking the drive battery cover, for example, and/or when replacing the drive battery cover. This means that the motor vehicle can assist the robot in these tasks, i.e., opening the drive battery cover and/or closing and/or locking the drive battery cover, for instance, and/or replacing the drive battery cover.

In one example embodiment of the method of the present invention, it is provided that the AVP operation specifies that the motor vehicle is guided in an at least highly automated manner to a drive battery replacement station of the parking lot at which the drive battery replacement device is located, so that the control of the drive battery replacement device does not take place until the electric motor vehicle is located at the drive battery replacement station.

This, for example, produces the technical advantage that the drive battery can be replaced efficiently.

In one example embodiment of the method of the present invention, it is provided that the drive battery cover is accessible from an underside of the electric motor vehicle, wherein the drive battery replacement station comprises a depression over which an electric motor vehicle can be positioned, wherein the AVP operation specifies that the motor vehicle is guided over the depression in an at least highly automated manner to position the electric motor vehicle over the depression, wherein the robot is controlled such that it replaces the drive battery from within the depression when the drive battery cover is open.

This, for example, may produce the technical advantage that the drive battery can be replaced efficiently.

In one example embodiment of the method of the present invention, it is provided that the robot includes a base part, which comprises a plurality of wheels or rollers, for example. In one embodiment of the method, it is provided that the robot comprises a gripper arm comprising a manipulator for opening and closing a drive battery cover of an electric motor vehicle, for example. The gripper arm is disposed on the base part, for instance.

The abbreviation “AVP” stands for “automated valet parking” and can be translated into German as “automatischer Parkservice” (automated parking service). An AVP operation includes, for example, guiding the motor vehicle in an at least highly automated manner from a drop-off position to a parking position and, for example, guiding the motor vehicle in an at least highly automated manner from a parking position to a pick-up position. A driver of the motor vehicle drops the motor vehicle off for an AVP operation at the drop-off position. The motor vehicle is picked up after the AVP operation has ended at a pick-up position.

A motor vehicle can therefore, for instance, also be referred to as an AVP motor vehicle within the meaning of the description as long as it is, for example, configured to carry out an AVP operation.

For example, it is provided that the AVP operation includes an AVP operation according to AVP type 1, 2, and/or 3, wherein AVP type 1 is a vehicle-based AVP operation, wherein AVP type 2 is an infrastructure-based AVP operation and wherein AVP type 3 is a vehicle-infrastructure-shared AVP operation.

This, for example, may produce the technical advantage that the AVP operation can be carried out efficiently.

AVP type 1 denotes a vehicle-based AVP operation. The primary responsibility for the AVP operation rests with the motor vehicle.

AVP type 2 denotes an infrastructure-based AVP operation. The primary responsibility for the AVP operation rests with the infrastructure, i.e. with the AVP system.

AVP type 3 denotes a vehicle-infrastructure-shared AVP operation. In this case, a primary responsibility for the AVP operation is shared between the motor vehicle and the AVP system.

An AVP operation includes the following procedures or functions:
1. Determining a target position, located in the parking lot, for the motor vehicle.
2. Planning a route from a start position, encompassed by the parking lot, to the target position.
3. Detecting an object and/or an event and a corresponding reaction to a detected object and/or a detected event.
4. Locating the motor vehicle in the parking lot.
5. Calculating a target trajectory for the motor vehicle based on the planned route.
6. Controlling a lateral and longitudinal guidance of the motor vehicle based on the calculated target trajectory.

The following table indicates an assignment showing which of these procedures or functions are carried out, depending on the AVP type, by the motor vehicle or by an infrastructure-side AVP system, which can, for instance, include the system according to the second aspect, wherein “I” stands for “infrastructure,” i.e., for the AVP system, and “K” stands for “motor vehicle”, so that “I” indicates that the procedure is carried out by the AVP system and “K” indicates that the procedure is carried out by the motor vehicle:

| Functions | AVP type 1 | AVP type 2 | AVP type 3 |
|---|---|---|---|
| Determining a target | I & K | I | I |
| position, located in | | | |
| the parking lot, for | | | |
| the motor vehicle. | | | |
| Planning a route from | K | I | I |
| a start position, | | | |
| comprised by the | | | |
| parking lot, to the | | | |
| target position. | | | |
| Detecting an object | K (& | I | I & K |
| and/or an event and a | optionally | | |
| corresponding | I) | | |
| reaction to a | | | |
| detected object | | | |
| and/or a detected | | | |
| event. | | | |
| Locating the motor | K | I | K |
| vehicle in the | | | |
| parking lot. | | | |
| Calculating a target | K | I | K |
| trajectory for the | | | |
| motor vehicle based | | | |
| on the planned route. | | | |
| Controlling a lateral | K | K | K |
| and longitudinal | | | |
| guidance of the motor | | | |
| vehicle based on the | | | |
| calculated target | | | |
| trajectory. | | | |

For each function, the above table thus indicates specifically for each AVP type whether the function is carried out by the infrastructure, i.e. by an infrastructure-side AVP system, or by the motor vehicle, i.e. for example, by a motor vehicle-side AVP system. In some cases, it can be provided that the function is carried out by both the infrastructure-side AVP system and the motor vehicle, i.e. the motor vehicle-side AVP system.

With regard to object detection and event detection for AVP type 1, it can optionally be provided that the AVP system of the infrastructure carries out this function as well, in addition to the motor vehicle.

The here-described AVP types 1, 2, and 3 are also described in detail in ISO 23374.

At least highly automated guidance includes highly automated guidance and/or fully automated guidance. The wording “at least highly automated” therefore includes one or more of the following: highly automated and fully automated.

Highly automated guidance means that, for a certain period of time, in a specific situation (for example: driving on a freeway, driving in a parking lot, passing an object, driving within a travel lane defined by lane markings), longitudinal guidance and lateral guidance of the motor vehicle are controlled automatically. A driver of the motor vehicle does not have to control the longitudinal and lateral guidance of the motor vehicle manually. The driver does not have to continuously monitor the automatic control of the longitudinal and lateral guidance in order to be able to intervene manually when necessary. If necessary, a take-over request is automatically issued to the driver to take over control of the longitudinal and lateral guidance, in particular issued with adequate time to respond. The driver therefore has to potentially be able to take control of the longitudinal and lateral guidance. Limits of the automatic control of the lateral and longitudinal guidance are recognized automatically. In highly automated guidance, it is not possible to automatically bring about a minimal risk state in every initial situation.

Fully automated guidance means that, in a specific situation (for example: driving on a freeway, driving in a parking lot, passing an object, driving within a travel lane defined by lane markings), longitudinal guidance and lateral guidance of the motor vehicle are controlled automatically. A driver of the motor vehicle does not have to control the longitudinal and lateral guidance of the motor vehicle manually. The driver does not have to monitor the automatic control of the longitudinal and lateral guidance in order to be able to intervene manually when necessary. Before the automatic control of the lateral and longitudinal guidance is ended, the driver is automatically prompted to take over the driving task (control of the lateral and longitudinal guidance of the motor vehicle), in particular with adequate time to respond. If the driver does not take over the driving task, the system automatically returns to a minimal risk state. Limits of the automatic control of the lateral and longitudinal guidance are recognized automatically. In all situations, it is possible to automatically return to a minimal risk system state.

The robot is a mobile robot, for instance.

In one example embodiment of the method of the present invention, it is provided that the method is a computer-implemented method.

Technical functionalities of the device result directly from corresponding technical functionalities of the method and/or the system and vice versa.

In one example embodiment of the method of the present invention, it is provided that the method is carried out by the device and/or by the system.

In one example embodiment of the method of the present invention, it is provided that a state of charge of the drive battery is ascertained, wherein determining that the drive battery of the electric motor vehicle needs to be replaced is carried out based on the ascertained state of charge.

This, for example, may produce the technical advantage that the determination can be carried out efficiently.

The ascertained state of charge is compared to a predetermined state of charge, for instance. For example, it is determined that the drive battery of the electric motor vehicle needs to be replaced when the ascertained state of charge is less than or less than or equal to the predetermined state of charge. Determining that the drive battery of the electric motor vehicle needs to be replaced is carried out based on the comparison between the ascertained state of charge and the predetermined state of charge, for example.

The terms state of charge and capacity can be used interchangeably.

The present invention is explained in more detail in the following with reference to preferred embodiment examples.

### BRIEF DESCRIPTION OF THE DRAWINGS

FIG. 1 shows a flowchart of a method for replacing a drive battery of an electric motor vehicle, according to an example embodiment of the present invention.

FIG. 2 shows a device according to an example embodiment of the present invention.

FIG. 3 shows a system for replacing a drive battery of an electric motor vehicle, according to an example embodiment of the present invention.

FIG. 4 shows a machine-readable storage medium, according to an example embodiment of the present invention.

FIG. 5 shows a parking lot with a first drive battery replacement station, according to an example embodiment of the present invention.

FIG. 6 shows the parking lot according to FIG. 5 with a second drive battery replacement station, according to an example embodiment of the present invention.

### DETAILED DESCRIPTION OF EXAMPLE EMBODIMENTS

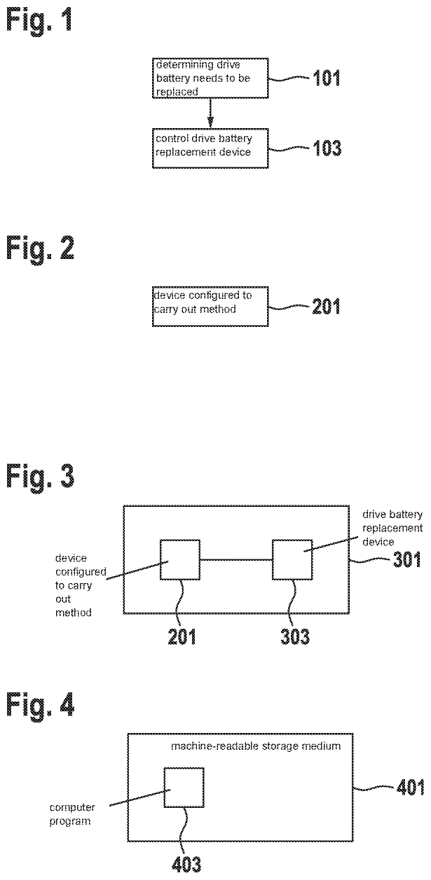

FIG. 1 shows a flowchart of a method for replacing a drive battery of an electric motor vehicle, comprising the following steps:
determining 101 that the drive battery of the electric motor vehicle needs to be replaced,
in response to the determination 101, controlling 103 a drive battery replacement device such that it automatically replaces the drive battery of the electric motor vehicle while the electric motor vehicle is carrying out an AVP operation in a parking lot.

In one embodiment of the method it is provided that the step of replacing the drive battery of the electric motor vehicle is included in the method.

FIG. 2 shows a device 201 which is configured to carry out all steps of the method for replacing a drive battery of an electric motor vehicle.

FIG. 3 shows a system 301 for replacing a drive battery of an electric motor vehicle, comprising: a drive battery replacement device 303 configured to replace a drive battery of an electric motor vehicle, and the device 201 according to FIG. 2.

FIG. 4 shows a machine-readable storage medium 401 on which a computer program 403 is stored. The computer program 403 comprises instructions that, when the computer program 403 is executed by a computer, prompt said computer to carry out a method for replacing a drive battery of an electric motor vehicle.

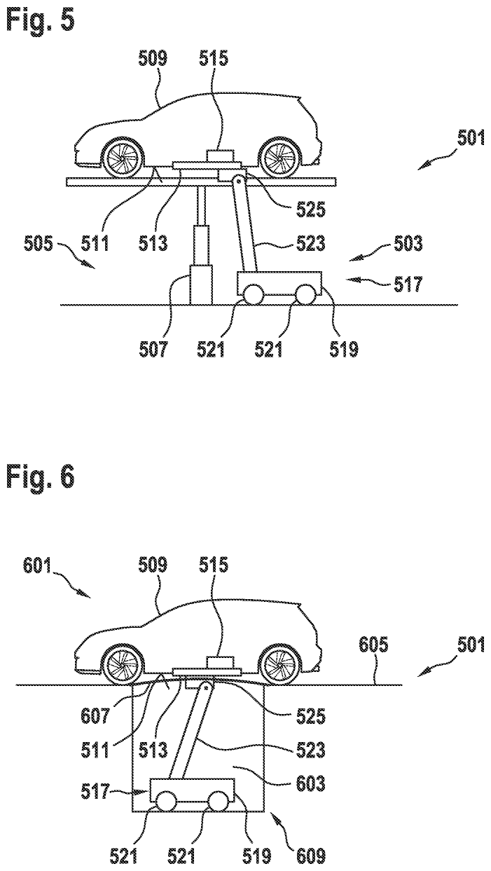

FIG. 5 shows a parking lot 501 comprising a first drive battery replacement device 503 disposed at a first drive battery replacement station 505. The first drive battery replacement device 503 includes a lifting platform 507 that has lifted an electric motor vehicle 509. A drive battery cover 513 behind which a drive battery 515 of the electric motor vehicle 509 is accessible is located on an underside 511 of the electric motor vehicle 509.

The first drive battery replacement device 503 includes a robot 517 which comprises a base part 519. On its underside, the base part 519 comprises wheels or rollers 521 so that the robot 517 is mobile, i.e. can travel. In a not depicted embodiment, the base part 519 does not have rollers 521. In other words, the robot 517 is, for instance, stationary.

According to a general embodiment, the robot 517 is a mobile robot, for example.

The robot 517 also comprises an arm 523, on the end facing away from the base part 519 of which a manipulator 525 is disposed. The manipulator 525 can be used to open the drive battery cover 513, replace the drive battery 515 and close the drive battery cover 513 after replacement.

Within the scope of an AVP operation, the electric motor vehicle 509 drives, for example in an at least highly automated manner, from a drop-off position to a parking position and from there, for example when the first drive battery replacement station 505 is free, in an at least highly automated manner to the first drive battery replacement station 505 and drives in an at least highly automated manner onto the lifting platform 507, which, of course, is then in the lowered state. The lifting platform 507 then automatically lifts the electric motor vehicle 509, so that the robot 517 can replace the drive battery 515 with appropriate control. After replacement, the lifting platform 507 lowers automatically, so that the electric motor vehicle 509 can drive in an at least highly automated manner, for example back to the parking position or to another parking position. The electric motor vehicle 509 can drive to a pick-up position, for example.

It should be noted here that the replacement of the drive battery 515 of the electric motor vehicle 509 can be carried out, for instance, at any time within the AVP operation. Such a time is selected such that the first drive battery replacement station 505 is used in an efficient and economical manner, for example. Such a time is selected such that the first drive battery replacement station 505 is optimally utilized, for example.

FIG. 6 shows a second drive battery replacement station 601 of the parking lot 501. The second drive battery replacement station 601 comprises a depression 603 within which the robot 517 can travel. The depression 603 is formed in a floor 605 of the parking lot 501. Two bridges 607 via which the electric motor vehicle 509 can drive over the depression 603 are provided so that, when the electric motor vehicle 509 is positioned over the depression 603, the robot 517 can open the drive battery cover 513 from within the depression 603, replace the drive battery 515 and close the drive battery cover 513 after replacement. Due to the perspective selected in FIG. 6, only one bridge 607 can be seen.

In a not depicted embodiment, the base part 519 does not have rollers 521. In other words, the robot 517 is, for instance, stationary.

In summary, the here-described features of the present invention in particular provide that a drive battery of an electric motor vehicle is not charged during an AVP operation, but is instead automatically replaced. The replacement is, for example, carried out when, for instance, a driver of the electric motor vehicle requests it, i.e., there is a corresponding request, and/or it is ascertained that the time required to charge the drive battery currently in the electric motor vehicle to a predetermined capacity is greater than or greater than or equal to a maximum possible charging time to charge the current drive battery. A driver of the electric motor vehicle specifies the maximum possible charging time, for instance. The maximum possible charging time is, for example, based on a pick-up time requested by the driver of the electric motor vehicle, at which the driver of the electric motor vehicle wants to pick up his electric motor vehicle. So, if the driver specifies that he wants to pick his electric motor vehicle up again after 3 hours, for example, a maximum possible charging time is 3 hours minus the travel time required for the motor vehicle to drive in an at least highly automated manner from a charging station of the parking lot to the pick-up position of the parking lot.

What is claimed is:

1. A method for replacing a drive battery of an electric motor vehicle, comprising the following steps:
determining that the drive battery of the electric motor vehicle needs to be replaced; and
in response to the determination, controlling a drive battery replacement device such that it automatically replaces the drive battery of the electric motor vehicle while the electric motor vehicle is carrying out an AVP operation in a parking lot.

2. The method according to claim 1, wherein it is determined that the drive battery of the electric motor vehicle needs to be replaced when there is an existing request to replace the drive battery.

3. The method according to claim 1, wherein the AVP operation specifies a maximum possible charging time for charging the drive battery in the parking lot, wherein a current capacity of the drive battery is ascertained, wherein it is determined that the drive battery of the electric motor vehicle needs to be replaced when the maximum possible charging time is not sufficient to charge the drive battery from the current capacity to a predetermined capacity, in the parking lot.

4. The method according to claim 1, wherein the drive battery replacement device includes a robot which is configured to replace the drive battery when the drive battery cover of the electric motor vehicle is open, wherein controlling the drive battery replacement device includes controlling the robot such that the robot replaces the drive battery when the drive battery cover of the electric motor vehicle is open.

5. The method according to claim 4, wherein the drive battery cover of the electric motor vehicle is accessible from an underside of the electric motor vehicle, wherein the drive battery replacement device includes a lifting platform which is configured to lift an electric motor vehicle to replace the drive battery from the underside, wherein the controlling of the drive battery replacement device includes controlling the lifting platform such that the lifting platform lifts the electric motor vehicle to replace the drive battery from the underside of the electric motor vehicle, and wherein the controlling of the drive battery replacement device includes controlling the robot such that, after lifting the electric motor vehicle using the lifting platform, the robot replaces the drive battery when the drive battery cover s open, and wherein the controlling of the drive battery replacement device includes controlling the lifting platform such that the lifting platform lowers the electric motor vehicle after the drive battery has been replaced.

6. The method according to claim 4, wherein the robot is configured to open the drive battery cover and/or close the drive battery cover after replacement, wherein the controlling of the drive battery replacement device includes controlling the robot such that the robot opens the drive battery cover and/or closes the drive battery cover after replacement.

7. The method according to claim 5, wherein the controlling of the drive battery replacement device includes controlling the robot such that, after lifting the electric motor vehicle using the lifting platform, the robot opens the drive battery cover accessible from the underside of the electric motor vehicle from the underside of the electric motor vehicle and/or closes the drive battery cover after replacing the drive battery, wherein controlling the drive battery replacement device includes controlling the lifting platform such that the lifting platform is lowered after closing the drive battery cover.

8. The method according to claim 1, wherein the AVP operation specifies that the motor vehicle is guided in an at least highly automated manner to a drive battery replacement station of the parking lot at which the drive battery replacement device s located, so that the control of the drive battery replacement device does not take place until the electric motor vehicle is located at the drive battery replacement station.

9. The method according to claim 8, wherein the drive battery replacement device includes a robot which is configured to replace the drive battery when the drive battery cover of the electric motor vehicle is open, wherein controlling the drive battery replacement device includes controlling the robot such that the robot replaces the drive battery when the drive battery cover of the electric motor vehicle is open, wherein the drive battery cover is accessible from an underside of the electric motor vehicle, wherein the drive battery replacement station includes a depression over which an electric motor vehicle can be positioned, wherein the AVP operation specifies that the motor vehicle is guided over the depression in an at least highly automated manner to position the electric motor vehicle over the depression, wherein the robot is controlled such that it replaces the drive battery from within the depression when the drive battery cover is open.

10. A device configured to replace a drive battery of an electric motor vehicle, the device configure to:
determine that the drive battery of the electric motor vehicle needs to be replaced; and
in response to the determination, control a drive battery replacement device such that it automatically replaces the drive battery of the electric motor vehicle while the electric motor vehicle is carrying out an AVP operation in a parking lot.

11. A system configured to replace a drive battery of an electric motor vehicle, comprising:
a drive battery replacement device configured to replace a drive battery of an electric motor vehicle; and
s device configured to:
determine that the drive battery of the electric motor vehicle needs to be replaced; and
in response to the determination, control the drive battery replacement device such that it automatically replaces the drive battery of the electric motor vehicle while the electric motor vehicle is carrying out an AVP operation in a parking lot.

12. A non-transitory machine-readable storage medium on which is stored a computer program for replacing a drive battery of an electric motor vehicle, the computer program, when executed by a computer, causing the computer to perform the following steps:
determining that the drive battery of the electric motor vehicle needs to be replaced; and
in response to the determination, controlling a drive battery replacement device such that it automatically replaces the drive battery of the electric motor vehicle while the electric motor vehicle is carrying out an AVP operation in a parking lot.
